(19) United States
(12) Patent Application Publication
(10) Pub. No.: US 2008/0226388 A1
(43) Pub. Date: Sep. 18, 2008

(54) Cabinet panel bracket

(76) Inventors: Ryan Prechtel, Huntingburg, IN (US); Ryan Bettag, Ferdinand, IN (US); Tammy Kemp, Leopold, IN (US); Patrick Foltz, Littlestown, PA (US); Keith Blackgrove, Huntingburg, IN (US); Daniel K. Buck, Jasper, IN (US)

Correspondence Address: CALFEE HALTER & GRISWOLD, LLP, 800 SUPERIOR AVENUE, SUITE 1400, CLEVELAND, OH, 44114, US

(21) Appl. No.: 11/717,277

(22) Filed: Mar. 13, 2007

(51) Int. Cl. F16D 3/16

(52) U.S. Cl. 403/345

(57) ABSTRACT

A toe kick panel bracket includes integral fasteners that can be pressed into holes in side cabinet panels. The toe kick panel holds side edges of the toe kick panel in place. A groove in a bottom cabinet panel may retain a top edge of the toe kick panel.

### TECHNICAL FIELD

The present invention is related to cabinet brackets used to join one or more cabinet panels to form a cabinet assembly.

### BACKGROUND

Most ground-level cabinets include a toe kick panel mounted to a front face of the cabinet below the doors. The toe kick panel adds stability to the cabinet assembly. The toe kick panel is often covered with a skin or veneer of decorative material and provides a more aesthetically pleasing appearance by closing off the space below the cabinet's bottom surface. Typically, toe kick panels are attached to the cabinet with a bracket or wooden cleat. These brackets and cleats require the use of separate fasteners and many place the toe kick panel in a position in which it protrudes beyond the front edge of the bottom side panel of the cabinet, making it difficult to install the veneer.

### SUMMARY

A toe kick panel bracket includes integral fastening features that can be used to join a toe kick panel to a cabinet. The toe kick bracket may be used to position the toe kick panel flush with the front edge of the side panel of the cabinet. The toe kick panel bracket may cooperate with a toe kick receiving groove in a bottom panel of the cabinet to locate the toe kick panel with respect to the cabinet.

Further features and advantages of the invention will become apparent from the following detailed description made with reference to the accompanying drawings.

### BRIEF DESCRIPTION OF THE DRAWINGS

FIG. 1 is an exploded fragmentary view of a cabinet assembly that includes a toe kick panel that is mounted to the cabinet by two toe kick panel brackets constructed in accordance with an embodiment of the present invention;

FIG. 2A is a perspective view of the toe kick panel bracket of FIG. 1;

FIG. 2B is a front plan view of the toe kick panel bracket of FIG. 1;

FIG. 2C is a partially cut away side plan view of the toe kick panel bracket of FIG. 1;

FIG. 2D is a fragmentary view of the toe kick panel bracket of FIG. 1 that shows an integral fastener;

FIGS. 3A-3D show exemplary steps that can be performed to install a toe kick panel on a cabinet using the toe kick panel bracket of FIG. 1;

FIG. 4 is a perspective view of a toe kick panel bracket constructed in accordance with another embodiment of the present invention; and

FIG. 5 shows a toe kick panel installed on a cabinet with a wooden cleat.

### DETAILED DESCRIPTION OF THE INVENTION

The Detailed Description of the Invention merely describes embodiments of the invention and is not intended to limit the scope of the claims in any way. Indeed, the invention as described is broader than and unlimited by the preferred embodiments, and the terms used have their full ordinary meaning.

A cabinet panel bracket is provided that mounts a first cabinet panel to a second cabinet panel. The first cabinet panel includes front and back surfaces and a side edge. The cabinet panel bracket includes a substantially planar base portion that has first and second surfaces. The first surface faces the side edge of the first cabinet panel. The bracket also includes at least one fastener that is integral to the base portion and protrudes from the base portion second surface. The fastener engages the second cabinet panel to fix the first cabinet panel to the second cabinet panel. In some embodiments, the base portion and fastener are integrally molded of the same material.

The fastener may be, for example, a generally cylindrical protrusion having a generally circular front face and a cylindrical outer perimeter. The generally cylindrical protrusion includes knurls about its outer perimeter and the front face includes a tapered edge such that the diameter of the front face is smaller than the diameter of the generally cylindrical protrusion. It should be apparent to others skilled in the art that the shape, size, and style of the fastener may vary in the practice of the invention.

The bracket may include spaced first and second bracket flanges extending perpendicularly from the base portion first surface and parallel to one another to form a substantially U-shaped bracket that defines a channel into which the first cabinet panel side edge is inserted. The first and second bracket flanges include a rounded corner at a termination of an edge distal from the base portion. The first and second bracket flanges may also have an outwardly tapered interior end surface to assist in installing a cabinet panel in the bracket. It should be apparent to others skilled in the art that the shape, size, and style of the bracket flanges may vary in the practice of the invention.

In some embodiments, a panel retaining barb protrudes from at least one of the base portion first surface and an inner surface of the first and second bracket flanges. The panel retaining barb may be conical in shape, however, it should be apparent to others skilled in the art that the shape, size, and style of the barb may vary in the practice of the invention.

A cabinet assembly that utilizes a toe kick panel bracket normally includes a pair of spaced side cabinet panels each having a front surface and a bottom cabinet panel that spans between the spaced side cabinet panels. The bottom cabinet panel has an upper surface that forms a cabinet bottom interior surface and a lower surface that forms a cabinet bottom exterior surface. The bottom cabinet panel spans the side cabinet panels at an intermediate position on the side panels to create a clearance cavity defined by the lower surface of the bottom cabinet panel, a floor upon which the cabinet rests, and the interior surface of the side cabinet panels. The lower surface of the bottom cabinet panel includes a groove that spans between the spaced side cabinet panels and has a front edge that is substantially coplanar with the front surface of the side cabinet panels. The cabinet also includes a toe kick panel that has a top edge inserted into the groove and side edges that each terminate at the interior surface of the side cabinet panels to substantially cover the front space of the clearance cavity. A toe kick panel bracket fixes a side edge of the toe kick panel to one of the side cabinet panels. The toe kick panel bracket includes a substantially planar base portion that has a base portion first surface that faces the side edge of the toe kick panel and at least one fastener that is integral to the base portion and protrudes from a base portion second surface. The at least one fastener engages the side cabinet panel to fix the toe kick panel to the side cabinet panel.

The cabinet assembly may also feature a side panel interior surface that has an engaging feature that cooperates with the toe kick bracket fastener to fix the toe kick panel to the side panel. The engaging feature may be, for example, a hole or depression sized to frictionally engage an outer surface of the toe kick bracket fastener.

A method is provided for fixing a first cabinet panel to a second cabinet panel. In this method, a cabinet panel bracket that is fixed onto the first cabinet panel is then fixed to the second cabinet panel. The cabinet panel bracket includes a substantially planar base portion that has a first surface that faces a side edge of the first cabinet panel. At least one fastener that is integral to the base portion and protrudes from a second surface of the base portion engages the second cabinet panel. Thus, the cabinet panel bracket and the first cabinet panel are fixed to the second cabinet panel. The side edge of the first cabinet panel is placed against the first surface of the base portion.

A third cabinet panel which forms the bottom of the cabinet may be grooved. In this embodiment, a top edge of the first cabinet panel may be inserted into the groove in the third cabinet panel and the fasteners are then pressed into engaging features in the second cabinet panel. A fourth cabinet panel may be used for the second side of the cabinet. The first cabinet panel is fixed to this fourth cabinet panel by a second cabinet panel bracket in the same fashion that the second cabinet panel is fixed to the first cabinet panel.

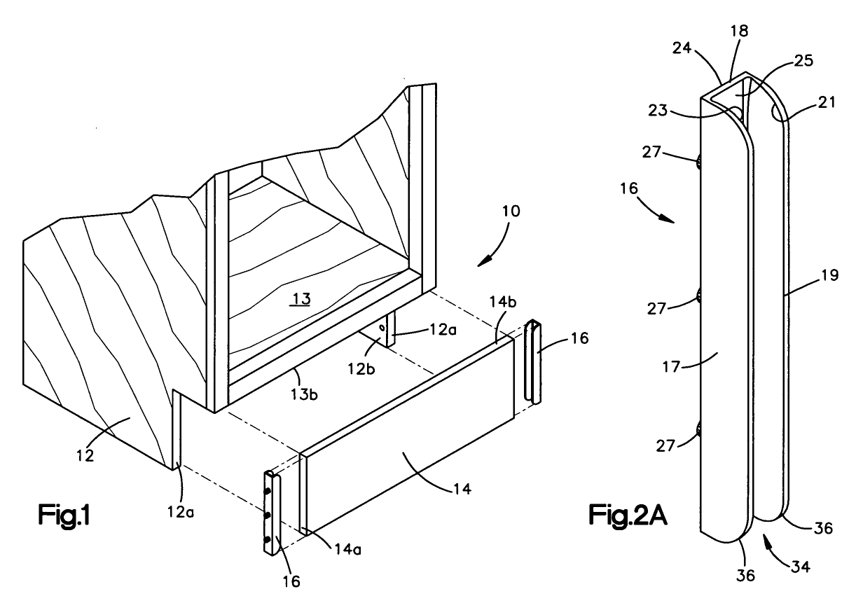

FIG. 1 shows a bottom portion of a cabinet 10. For the purposes of this description only, the cabinet 10 is a wooden cabinet such as those used in most kitchens, however, the cabinet bracket described herein can be employed in connection with any cabinet or structure in which it is desirable to join two panels together. The cabinet 10 includes two side panels 12 that have a front bottom edge 12a and an interior surface 12b. The side panel front bottom edge 12a may be cut away so that it falls behind a front surface of the cabinet 10, as shown in FIG. 1, or the front bottom edge may be flush with the rest of the front surface of the cabinet. The cabinet includes a bottom panel 13 that spans the two side panels at an intermediate position along the side panels to form a clearance area between the bottom panel and the floor upon which the cabinet rests. A toe kick panel 14 is shown removed from the cabinet 10. The toe kick panel includes two side edges 14a and a top edge 14b. As will be described in more detail below, the toe kick panel is connected to the side panel interior surface 12b by a pair of toe kick panel brackets 16 that are installed on the side panel interior surface and engage the toe kick side edges 14a. Once the toe kick panel is installed, a veneer or skin may be installed over the toe kick panel.

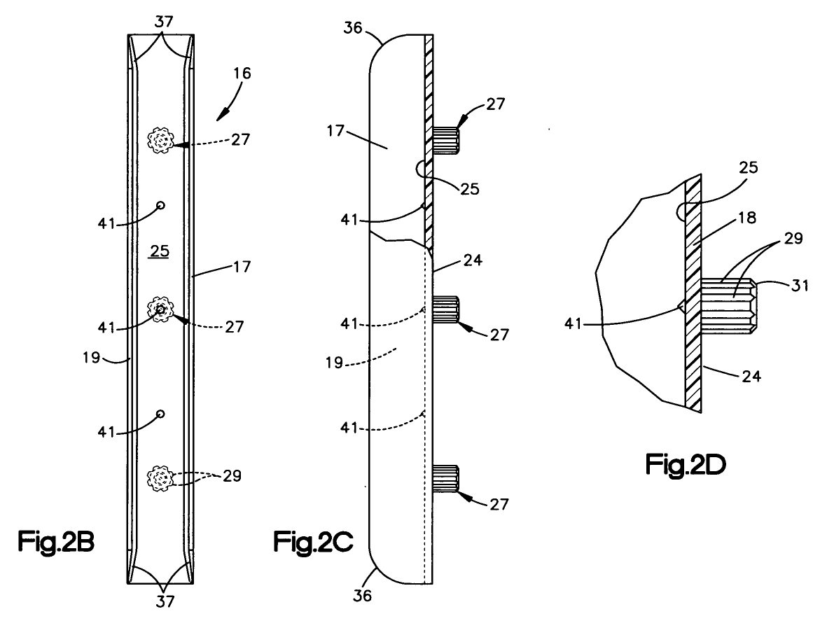

FIGS. 2A-2D are various views of the toe kick panel bracket 16. The toe kick panel bracket 16 includes a base portion 18 that has an inner surface 25 and outer surface 24. A pair of spaced bracket flanges 17, 19 project perpendicularly from the base portion 18 to form a channel 34 that is defined by the base portion inner surface 25 and bracket flange inner surfaces 21, 23. The channel is sized to closely fit with the toe kick panel side edge such that the toe kick panel can be inserted into the bracket by hand. The bracket flanges have a rounded corner 36 at the termination of an edge of the bracket flange that is distal from the base portion 25. The bracket flanges also include an outwardly tapered interior end surface 37, as best seen in FIG. 2B, to facilitate installation of the toe kick panel in the bracket. Also shown in FIG. 2b, the exemplary spaced bracket flanges 17, 19 are angled slightly toward each other. This arrangement creates a pinching effect on the toe kick panel upon insertion. The bracket flanges 17, 19 may also have a spring bias.

The toe kick panel bracket 16 includes one or more integral fasteners 27 with which it is fixed to the side panel. As can be seen best in FIG. 2D, the illustrated fasteners 27 have a generally cylindrical shape and protrude from the outer surface 24 of the base portion. The fasteners 27 may have knurls 29 or spokes about their outer perimeter to provide better bracket retention when the fastener is inserted into the side panel. To facilitate installation, the fasteners 27 include a tapered edge 31 at their leading face. While cylindrical protrusions are described herein, any type, style, shape or size of fastener that can be constructed integrally with the toe kick panel bracket could be used. In some embodiments, the toe kick panel bracket 16 is molded from plastic with the fasteners forming a part of the mold, but the fasteners could be manufactured separately and fixed to the base portion outer surface 24 prior to, or concurrently with, use in cabinet construction.

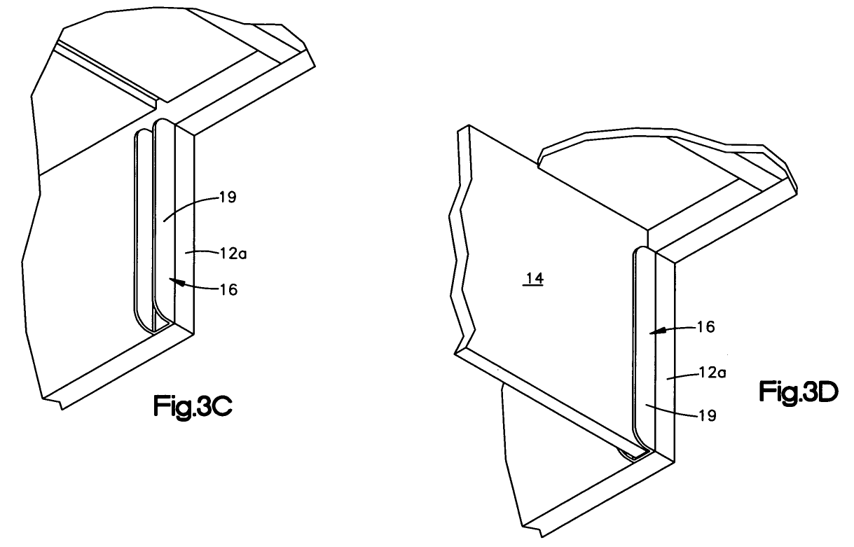

In some embodiments, the toe kick panel bracket 16 includes conically shaped panel retention barbs 41 (FIG. 2B-2D), 43 (FIG. 4) on one or more inner surfaces of the bracket. For example, the barbs 41 can be located on the interior surface 25 as shown in FIGS. 2A-2D. Alternatively, or additionally, the barbs 43 can be located on the interior surface 21 or 23 as shown in FIG. 4. It is believed that the barbs increase frictional forces against the toe kick panel when engaged in the bracket to prohibit lateral or longitudinal movement. Although a specific quantity of conical shaped barbs are shown in the drawings, it should be apparent to others skilled in the art that the quantity, shape, size, location, and style of the barbs may vary in the practice of the invention.

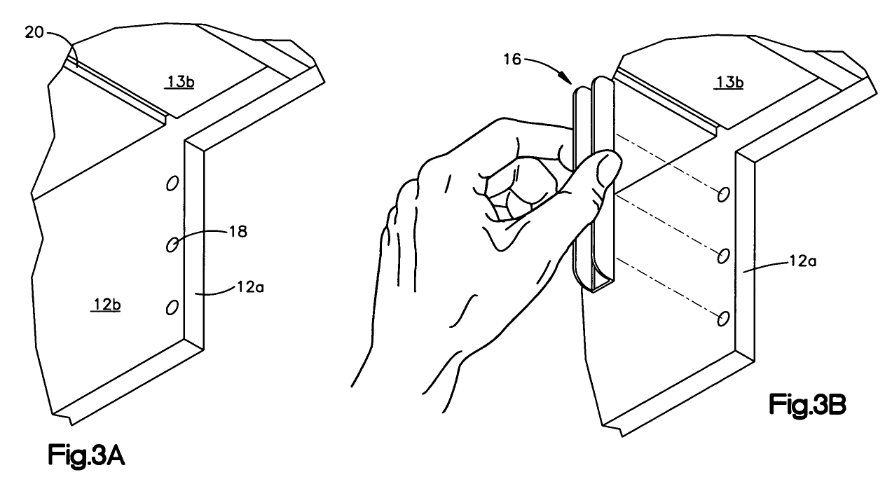

FIGS. 3A-3D illustrate steps that can be used to install a toe kick panel to a side cabinet panel using the toe kick panel bracket 16. In FIG. 3A, a bottom side portion of the cabinet is shown including the side panel front bottom edge 12a and a bottom cabinet panel bottom surface 13b. Fastener engaging holes 18 are drilled into the side panel interior surface. The holes are sized to frictionally engage the fasteners 27 while allowing for a press fit that can be accomplished by hand. A groove 20 is cut in the bottom cabinet panel bottom surface. A front edge of the groove is substantially coplanar with the side panel front bottom edge 12a. The groove 20 is sized to closely fit around the toe kick panel top edge 14b.

In FIG. 3B, the toe kick panel bracket 16 is shown in its installation orientation. The fasteners are aligned with the fastener engaging holes 18. In FIG. 3C, the fasteners 27 have been pressed into the holes. The toe kick panel bracket 16 is now in position to mount a toe kick panel to the side panel. A front most edge of the bracket flanges 19 is coplanar with the side panel front edge 12a. In FIG. 3D, the toe kick panel 14 has been inserted into the channel formed by the toe kick panel bracket 16 and into the groove 20 so that it is now fixed in location on three sides. The toe kick panel 16 is mounted substantially flush with the side panel front edge 12a and both ends of the toe kick panel are concealed within the toe kick panel brackets 16.

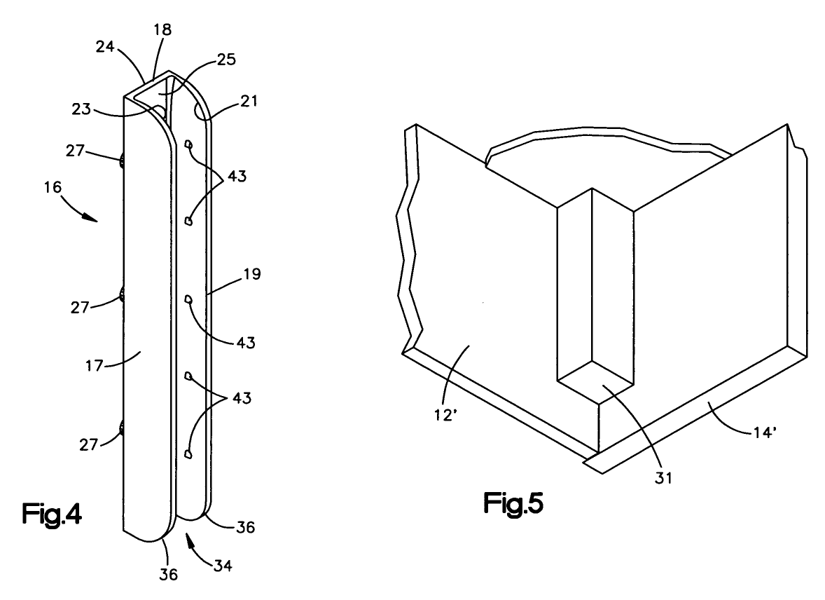

FIG. 5 illustrates a toe kick panel 14′ that has been installed on a side panel 12′ using a conventional wooden cleat 31 that is glued or nailed to the side panel as is presently practiced in the art. As can be seen from the above description and drawings, the toe kick panel bracket 16 alleviates the need for the wooden cleat and the glue or fasteners that are required to fix the cleat in place.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

We claim:

1. A cabinet panel bracket that mounts a first cabinet panel to a second cabinet panel, wherein the first cabinet panel includes front and back surfaces and a side edge, the cabinet panel bracket comprising:
a substantially planar base portion that has first and second surfaces and wherein the first surface faces the side edge of the first cabinet panel; and
at least one fastener that is integral to the base portion and protrudes from the base portion second surface that engages the second cabinet panel to fix the first cabinet panel to the second cabinet panel.

2. The cabinet panel bracket of claim 1 wherein the base portion and fastener are integrally molded of the same material.

3. The cabinet panel bracket of claim 1 wherein the at least one fastener is a generally cylindrical protrusion having a generally circular front face and a cylindrical outer perimeter.

4. The cabinet panel bracket of claim 3 wherein the generally cylindrical protrusion includes knurls about its outer perimeter.

5. The cabinet panel bracket of claim 3 wherein the front face includes a tapered edge such that the diameter of the front face is smaller than the diameter of the generally cylindrical protrusion.

6. The cabinet panel bracket of claim 1 further comprising spaced first and second bracket flanges extending from the base portion first surface and parallel to one another to form a substantially U-shaped bracket that defines a channel into which the first cabinet panel side edge is inserted.

7. The cabinet panel bracket of claim 6 wherein the at least one of the first and second flanges includes a rounded corner at a termination of an edge distal from the base portion.

8. The cabinet panel bracket of claim 1 further comprising one or more panel retention barbs protruding from the first surface of the base portion.

9. The cabinet panel bracket of claim 8 wherein the one or more panel retention barbs has a generally conical shape.

10. The cabinet panel bracket of claim 6 further comprising one or more panel retention barbs protruding from an inner surface of at least one of the first and second bracket flanges.

11. The cabinet panel bracket of claim 10 wherein the one or more panel retention barbs has a generally conical shape.

12. The cabinet panel bracket of claim 6 wherein the at least one of the first and second flanges includes an outwardly tapered interior end surface.

13. The cabinet panel bracket of claim 6 wherein the first and second flanges extend perpendicularly from the base portion.

14. The cabinet panel bracket of claim 6 wherein the first and second flanges extend at a slightly acute angle to the base portion.

15. A cabinet assembly comprising:
a pair of spaced side cabinet panels each having a front edge;
a bottom cabinet panel that spans between the spaced side cabinet panels and having a upper surface that forms a cabinet bottom interior surface and a lower surface that forms a cabinet bottom exterior surface; wherein the bottom cabinet panel spans the side cabinet panels at an intermediate position on the side panels to create a clearance cavity defined by the lower surface, a floor upon which the cabinet rests, and the interior surface of the side cabinet panels; and wherein the lower bottom cabinet panel surface includes a groove that spans between the spaced side cabinet panels, the groove having a front edge that is substantially coplanar with the front edge of the side cabinet panels;
a toe kick panel having a top edge inserted into the groove and side edges that each terminate at the interior surface of the side cabinet panels to substantially cover a front surface of the clearance cavity; and
a toe kick panel bracket that fixes a side edge of the toe kick panel to one of the side cabinet panels, the toe kick panel bracket including a substantially planar base portion that has a base portion first surface that faces the side edge of the toe kick panel and at least one fastener that is integral to the base portion and protrudes from a base portion second surface that engages the side cabinet panel to fix the toe kick panel to the side cabinet panel.

16. The cabinet assembly of claim 15 wherein the base portion of the toe kick panel and fastener of the toe kick panel are integrally molded of the same material.

17. The cabinet assembly of claim 15 wherein the at least one fastener is a generally cylindrical protrusion having a generally circular front face and a cylindrical outer perimeter.

18. The cabinet assembly of claim 17 wherein the generally cylindrical protrusion includes knurls about its outer perimeter.

19. The cabinet assembly of claim 17 wherein the front face includes a tapered edge such that the diameter of the front face is smaller than the diameter of the generally cylindrical protrusion.

20. The cabinet assembly of claim 15 wherein the toe kick bracket further comprises spaced first and second bracket flanges extending from the base portion first surface and parallel to one another to form a substantially U-shaped bracket that defines a channel into which the first cabinet panel side edge is inserted.

21. The cabinet assembly of claim 20 wherein the at least one of the first and second flanges includes a rounded corner at a termination of an edge distal from the base portion.

22. The cabinet assembly of claim 15 wherein the side panel interior surface includes an engaging feature that co acts with the toe kick bracket fastener to fix the toe kick panel to the side panel.

23. The cabinet assembly of claim 22 wherein the engaging feature is a hole sized to frictionally engage an outer surface of the toe kick bracket fastener.

24. The cabinet assembly of claim 15 further comprising one or more panel retention barbs protruding from the first surface of the base portion.

25. The cabinet assembly of claim 24 wherein the one or more panel retention barbs has a generally conical shape.

26. The cabinet assembly of claim 20 further comprising one or more panel retention barbs protruding from an inner surface of at least one of the first and second bracket flanges.

27. The cabinet assembly of claim 26 wherein the one or more panel retention barbs has a generally conical shape.

28. The cabinet assembly of claim 15 comprising a second toe kick panel bracket that fixes an opposing side edge of the toe kick panel to the other of the side cabinet panels.

29. The cabinet assembly of claim 20 wherein the at least one of the first and second flanges includes an outwardly tapered interior end surface.

30. The cabinet assembly of claim 20 wherein the first and second flanges extend perpendicularly from the base portion.

31. The cabinet assembly of claim 20 wherein the first and second flanges extend at a slightly acute angle to the base portion.

32. A method for fixing a first cabinet panel to a second cabinet panel comprising:
fixing a cabinet panel bracket to the second cabinet panel, the cabinet panel bracket including a substantially planar base portion that has a first surface that faces a side edge of the first cabinet panel and at least one fastener that is integral to the base portion and protrudes from a second surface of the base portion, wherein the fastener engages the second cabinet panel to fix the cabinet panel bracket to the second cabinet panel; and
placing the side edge of the first cabinet panel against the first surface of the base portion.

33. The method of claim 32 wherein the cabinet panel bracket further comprises spaced first and second bracket flanges extending perpendicularly from the base portion first surface and parallel to one another to form a substantially U-shaped bracket that defines a channel and wherein the step of placing the side edge of the first cabinet panel against the base portion first surface is performed by inserting the side edge of the first cabinet panel into the channel.

34. The method of claim 32 comprising the step of grooving a third cabinet panel and wherein the step of placing the side edge of the first cabinet panel against the base portion first surface is done by inserting a top edge of the first cabinet panel into the groove in the third cabinet panel.

35. The method of claim 32 comprising the step of forming fastener engaging features in the second cabinet panel.

36. The method of claim 32 comprising the step of engaging one or more panel retention barbs on an interior surface of the cabinet panel bracket with at least one surface of the first cabinet panel.

37. The method of claim 32 wherein the first cabinet panel is fixed to a third cabinet panel, the method comprising the steps of:
fixing a second cabinet panel bracket to the third cabinet panel such that the fastener engages the third cabinet panel to fix the cabinet panel bracket to the third cabinet panel; and
placing an opposing side edge of the first cabinet panel against the first surface of the base portion of the second cabinet panel.
